(19) United States
(12) Patent Application Publication
(10) Pub. No.: US 2011/0265930 A1
(43) Pub. Date: Nov. 3, 2011

(54) METHOD FOR ADHERING METAL WORKPIECES AND PLASTIC WORKPIECES

(75) Inventors: HSING-YUAN HSIEH, Shindian (TW); SHI-CHAO YU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/886,663

(22) Filed: Sep. 21, 2010

(30) Foreign Application Priority Data
Apr. 30, 2010 (CN) 201010160976.7

(51) Int. Cl. B32B 37/12; B32B 37/10; B32B 37/08

(52) U.S. Cl. 156/64

(57) ABSTRACT

A method of adhering metal workpieces with plastic workpieces includes the steps: measuring surface tolerances of the adhering surfaces of the metal workpiece and plastic workpiece. Providing a first adhesive and a second adhesive with predetermined thickness according to the measured surface tolerances; pressing the first adhesive and the second adhesive against the metal workpiece and the plastic workpiece; hot pressing the metal workpiece against the plastic workpiece; cooling the hot-pressed metal workpiece and the plastic workpiece.

### BACKGROUND

1. Technical Field

The present disclosure relates to A method for adhering a metal workpiece with a plastic workpiece.

2. Description of the Related Art

Typically, a metal workpiece is adhered to the plastic workpiece by a single adhesive. However, the existence of pores in or protrusions on, the adhering surfaces may badly affect the adhesion of the metal workpiece and the plastic workpiece. Additionally, a single adhesive for the adhesion cannot always achieve a firm bonding of the metal workpiece and the plastic workpiece.

Therefore, there is room for improvement within the art.

### DETAILED DESCRIPTION

A method according to an embodiment is disclosed to adhere a metal workpiece with a plastic workpiece as an integral unit and effectively reduce the surface tolerance between the metal workpiece and the plastic workpiece. The surface tolerance may be caused by protrusions or pores of the adhering surfaces of the metal workpiece and the plastic workpiece. Additionally, the metal workpiece has a first adhesive attached on the adhering surface. The plastic workpiece has a second adhesive attached on the adhering surface corresponding to the first adhesive. The first adhesive and second adhesive can be polymers comprised of thermoplastic resin adhesive, adhesion agent, viscosity modifier and an inhibitor. The first adhesive and second adhesive can be hot melted and fluid under pressure and heating.

The method can be exemplified to include the following steps. The metal workpiece and the plastic workpiece are provided. The surface tolerances of the adhering surfaces of the metal workpiece and the plastic workpiece can be measured with a microscope. If the adhering surface has pores, the corresponding surface tolerance has a negative value. If the adhering surface has protrusions, the corresponding surface tolerance has a positive value.

The first adhesive and the second adhesive are provided with their predetermined thickness according to the measured surface tolerances. Specifically, the first adhesive and the second adhesive may be of a standard thickness such as about 1 mm. When the adhering surface of the metal workpiece has a positive surface tolerance for example about 0.2 mm, the thickness of the corresponding first adhesive can be calculated by subtracting the standard thickness with the positive surface tolerance. The thickness of the first adhesive is about 0.8 mm. When the adhering surface of the metal workpiece has a negative surface tolerance such as of about minus 0.3 mm, the thickness of the first adhesive can be calculated by adding the absolute value of the surface tolerance with the standard thickness, so that the first adhesive is about 1.3 mm thick.

When the adhering surface of the plastic workpiece has a positive surface tolerance for example about 0.1 mm, the thickness of the corresponding second adhesive can be calculated by subtracting the standard thickness with the positive surface tolerance, so that the second adhesive is about 0.9 mm thick. When the adhering surface of the plastic workpiece has a surface tolerance for example about minus 0.15 mm, the thickness of the first adhesive can be calculated by adding the absolute value of the surface tolerance with the standard thickness, so that the corresponding second adhesive is about 1.15 mm thick.

The first adhesive and the second adhesive can be respectively pressed to attach on the adhering surfaces of the first and plastic workpiece. After that, a hot-press machine is provided to hot press the plastic workpiece and the metal workpiece together. The first adhesive and the second adhesive are oppositely pressed. Heat from the hot-press machine is transmitted from the metal workpiece to the first and second adhesives. In this case, the first and second adhesives are melted, flow and then fill into pores of the adhering surfaces or flushing with the protrusions of the adhering surfaces.

During the pressing of the first and second adhesives against the metal and plastic workpieces, the temperature can range from about 50° C. to about 180° C., the pressure can be in a range from about 0.2 mpa to about 1.5 mpa. This process can last about 1 second to about 8 seconds. During the hot-pressing, the temperature is about 100° C. to about 250° C., the pressure is about 0.35 mpa to about 2.25 mpa, and the processing lasts from about 3 seconds to about 20 seconds.

Additionally, the hot-pressed metal workpiece and the plastic workpiece may be cooled by spraying Nitrogen gas or carbon oxide gas from the hot-press machine. The first adhesive and second adhesive firmly adhere the metal workpiece to the plastic workpiece. The first adhesive locks with the second adhesive, thus, adhering the metal workpiece with the plastic workpiece. The surface tolerance of the adhered surfaces can be decreased to substantially zero level. The metal workpiece in combination with the first adhesive can have the same thickness along the entire adhering surface. The plastic workpiece in combination with the second adhesive can have the same thickness along the entire adhering surface.

In one exemplary embodiment, the metal workpiece is made of iron and has a thickness of about 8 mm. The plastic workpiece has a thickness of about 10 mm. The first adhesive corresponding to the metal workpiece may be a hot melt pressure-sensitive rubber resin adhesive, such as that used on 690 Colored Film Tape, sold by 3M®. The second adhesive corresponding to the plastic workpiece may be a flexible hot melt adhesive bonding film, such as that used on 615S Thermo-Bonding Film, sold by 3M®. The standard thickness of the first and second adhesives is defined at about 2 mm. For compensating the surface tolerances of the adhering surfaces of the metal and plastic workpieces, the thickness of first and second adhesives is in a range from about 1.5 mm to about 2.5 mm. The entire thickness of the combination of the metal workpiece, the plastic workpiece, the first adhesive, and the second adhesive is about 19.5 mm to about 20.5 mm.

During the pressing of the first adhesive against the metal workpiece, the temperature can be about 90° C. to about 110° C., and the pressure can range from about 0.35 mpa to about 0.45 mpa. This process can last from about 1 second to about 3 seconds. During the pressing of the second adhesive against the plastic workpiece, the temperature can be from about 90° C. to about 110° C., and the pressure can be in a range from about 0.35 mpa to about 0.45 mpa. This process can last from about 1 second to about 3 seconds. During the hot-pressing, the temperature is from about 180° C. to about 200° C., the pressure is from about 0.45 mpa to about 0.55 mpa, and the processing period is from about 5 seconds to about 7 seconds.

It is to be understood that even though numerous characteristics and advantages of the present embodiments have been set forth in the foregoing description, together with details of assemblies and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method of adhering a metal workpiece with a plastic workpiece, the metal workpiece and the plastic workpiece each having adhering surfaces, the method comprising:
measuring surface tolerances of the adhering surfaces of the metal workpiece and plastic workpiece;
providing a first adhesive to the adhering surface of the metal workpiece, with a thickness determined by the measured surface tolerance of adhering surface of the metal workpiece;
providing a second adhesive to the adhering surface of the plastic workpiece, with a thickness determined by the measured surface tolerance of the adhering surface of the plastic workpiece;
pressing the first adhesive against the metal workpiece;
pressing the second adhesive against the plastic workpiece;
hot pressing the metal workpiece against the plastic workpiece;
cooling the hot-pressed metal workpiece and the plastic workpiece.

2. The method as claimed in claim 1, wherein the hot-pressed metal workpiece and the plastic workpiece are cooled by spraying gas.

3. The method as claimed in claim 2, wherein the gas is Nitrogen gas, carbon oxide gas or a combination thereof.

4. The method as claimed in claim 1, wherein the first adhesive is provided with a standard thickness, when the adhering surface of the metal workpiece has a positive surface tolerance, the thickness of the corresponding first adhesive is calculated by minusing the standard thickness with the positive surface tolerance, when the adhering surface of the metal workpiece has a negative surface tolerance, the thickness of the first adhesive is calculated by adding the absolute value of the surface tolerance with the standard thickness.

5. The method as claimed in claim 4, wherein the second adhesive is provided with a standard thickness, when the adhering surface of the plastic workpiece has a positive surface tolerance, the thickness of the corresponding second adhesive is calculated by subtracting the standard thickness with the positive surface tolerance, when the adhering surface of the plastic workpiece has a negative surface tolerance, the thickness of the second adhesive is calculated by adding the absolute value of the surface tolerance with the standard thickness.

6. The method as claimed in claim 1, wherein the first adhesive and the second adhesive is a polymer comprised of thermoplastic resin adhesive, adhesion agent, viscosity modifier and inhibitor.

7. The method as claimed in claim 1, wherein the first adhesive is a polymer comprised of thermoplastic resin adhesive, adhesion agent, viscosity modifier and antioxidant.

8. The method as claimed in claim 1, wherein the pressing of the first and second adhesives against the metal and plastic workpieces is provided with a temperature about 50° C.˜180° C., a pressure about 0.2˜1.5 mpa, and lasts about 1˜8 seconds.

9. The method as claimed in claim 1, wherein the hot-pressing is provided with a temperature about 100˜250° C., a pressure about 0.35˜2.25mpa, and lasts about 3˜20 seconds.
